(19) United States
(12) Patent Application Publication
(10) Pub. No.: US 2024/0087549 A1
(43) Pub. Date: Mar. 14, 2024

(54) MUSICAL SCORE CREATION DEVICE, TRAINING DEVICE, MUSICAL SCORE CREATION METHOD, AND TRAINING METHOD

(71) Applicant: Yamaha Corporation, Hamamatsu (JP)

(72) Inventor: Masahiro SUZUKI, Hamamatsu (JP)

(21) Appl. No.: 18/512,133

(22) Filed: Nov. 17, 2023

Related U.S. Application Data
(63) Continuation of application No. PCT/JP2022/010125, filed on Mar. 8, 2022.

(30) Foreign Application Priority Data
May 19, 2021 (JP) 2021-084905

(51) Int. Cl. G10H 1/00; G06N 20/00

(52) U.S. Cl. CPC G10H 1/0025; G06N 20/00; G10H 2210/111

(57) ABSTRACT

A musical score creation device includes at least one processor configured to execute a receiving unit configured to receive a note sequence that includes a plurality of musical notes, and an estimation unit configured to, by using a trained model, estimate each note and attribute information for creating a musical score. The trained model is a machine-learning model that has learned an input-output relationship between a reference note sequence including a plurality of reference notes, and each reference note and reference attribute information for creating a reference musical score.

### CROSS-REFERENCE TO RELATED APPLICATIONS

This application is a continuation application of International Application No. PCT/JP2022/010125, filed on Mar. 8, 2022, which claims priority to Japanese Patent Application No. 2021-084905 filed in Japan on May 19, 2021. The entire disclosures of International Application No. PCT/JP2022/010125 and Japanese Patent Application No. 2021-084905 are hereby incorporated herein by reference.

### BACKGROUND

### Technological Field

This disclosure relates to a musical score creation device, a training device, a musical score creation method, and a training method for creating musical scores.

### Background Information

Technologies for creating musical scores are known, for example, from Japanese Laid-Open Patent Application Publication No. 2005-195827 and Japanese Laid-Open Patent Application Publication No. 2018-533076. Japanese Laid-Open Patent Application Publication No. 2005-195827 discloses analyzing automatic performance data in MIDI (Musical Instrument Digital Interface) format to generate musical score display data. Japanese Laid-Open Patent Application Publication No. 2018-533076 discloses extracting musical note properties from a music data object such as a standard MIDI file, determining an associate musical note syllable based on the musical note properties, and generating a visual musical score in accordance with the musical note properties.

### SUMMARY

A practical musical score includes not only musical notes but also various attribute information of the musical notes. However, in the technology of Japanese Laid-Open Patent Application Publication No. 2005-195827 or Japanese Laid-Open Patent Application Publication No. 2018-533076, attribute information cannot be estimated from the MIDI data. Therefore, it is difficult to create a practical musical score.

The object of this disclosure is to provide a musical score creation device, a training device, a musical score creation method, and a training method that can create practical musical scores.

A musical score creation device according to one aspect of this disclosure comprises at least one processor configured to execute a receiving unit configured to receive a note sequence that includes a plurality of musical notes, and an estimation unit configured to, by using a trained model, estimate each note and attribute information for creating a musical score. The trained model is a machine-learning model that has learned an input-output relationship between a reference note sequence including a plurality of reference notes, and each reference note and reference attribute information for creating a reference musical score.

A musical score creation device according to another aspect of this disclosure comprises at least one processor configured to execute a receiving unit configured to receive an input note token sequence, which is performance data including information on a musical note, a part, a beat, and a bar, an estimation unit configured to estimate a musical score token sequence from the input note token sequence, by using a trained model that has been trained by using a musical note token sequence for learning as an input and a musical score element token sequence as an output, and a creation unit configured to create an image musical score from the musical score token sequence. The musical score element token sequence is converted from a reference image musical score and including information on a musical note drawing, an attribute, and a bar, and the musical note token sequence for learning is created from the musical score element token sequence.

A training device according to yet another aspect of this disclosure comprises at least one processor configured to execute a first acquisition unit configured to acquire a reference note sequence including a plurality of reference notes, a second acquisition unit configured to acquire each reference note and reference attribute information for creating a musical score, and a construction unit configured to construct a trained model that has learned an input-output relationship between the reference note sequence, and each reference note and the reference attribute information.

A musical score creation method according to yet another aspect of this disclosure is executed by a computer, and comprises receiving a note sequence including a plurality of musical notes, and estimating each note and attribute information for creating a musical score, by using a trained model. The trained model is a machine learning model that has learned an input-output relationship between a reference note sequence including a plurality of reference notes, and each reference note and reference attribute information for creating a reference musical score.

A training method according to yet another aspect of this disclosure is executed by a computer, and comprises acquiring a reference note sequence including a plurality of reference notes, acquiring each reference note and reference attribute information for creating a musical score, and constructing a trained model that has learned an input-output relationship between the reference note sequence, and each reference note and the reference attribute information.

### BRIEF DESCRIPTION OF THE DRAWINGS

FIG. 1 is a block diagram of the configuration of a processing system including a musical score creation device and a training device according to one embodiment of this disclosure.

FIG. 2 is a diagram showing an example of a musical note token sequence for learning in each piece of training data.

FIG. 3 is a piano roll represented by a musical note token sequence for learning of FIG. 2.

FIG. 4 is a diagram showing an example of the musical score element token sequence in each piece of training data.

FIG. 5 is a musical score represented by the musical score element token sequence of FIG. 4.

FIG. 6 is a diagram showing another example of the musical score element token sequence in each piece of training data.

FIG. 7 is a diagram showing another example of the musical score element token sequence denoting a clef.

FIG. 8 is a diagram showing another example of the musical score element token sequence denoting a clef.

FIG. 9 is a diagram showing another example of the musical score element token sequence denoting a clef.

FIG. 10 is a block diagram of the configuration of a training device and a musical score creation device.

FIG. 11 is a diagram showing an example of an image musical score.

FIG. 12 is a flowchart showing an example of a training process performed by the training device of FIG. 10.

FIG. 13 is a flowchart showing an example of a musical score creation process performed by the musical score creation device of FIG. 10.

FIG. 14 is a diagram used to explain the operation of a receiving unit in another embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### (1) Configuration of the Processing System

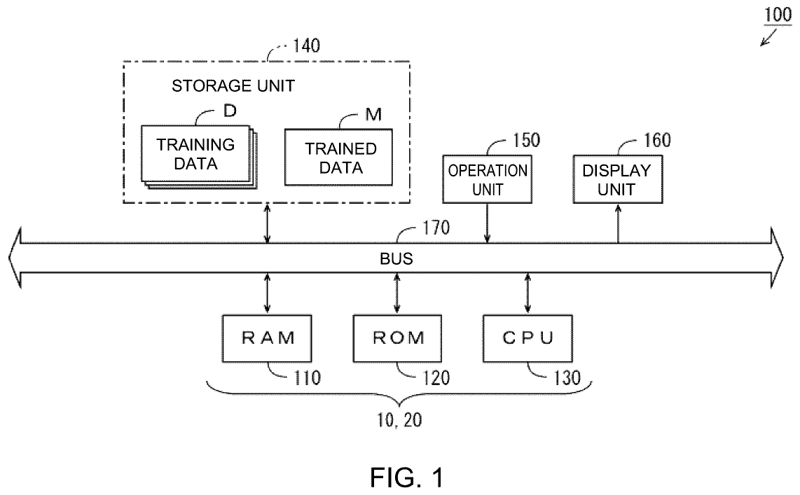

A musical score creation device, a training device, a musical score creation method, and a training method according to an embodiment of this disclosure will be described in detail below with reference to the drawings. FIG. 1 is a block diagram of the configuration of a processing system including a musical score creation device and a training device according to an embodiment of this disclosure. As shown in FIG. 1, a processing system 100 includes a RAM (random access memory) 110, a ROM (read only memory) 120, a CPU (central processing unit) 130, a storage unit 140, an operation unit 150, and a display unit 160.

The processing system 100 is realized by a computer, such as a personal computer, a tablet terminal, or a smartphone. Alternatively, the processing system 100 can be realized by co-operative operation of a plurality of computers connected by a communication channel, such as the Internet, or can be realized by an electronic instrument equipped with a performance function such as an electronic piano.

The RAM 110, the ROM 120, the CPU 130, the storage unit 140, the operation unit 150, and the display unit 160 are connected to a bus 170. The RAM 110, the ROM 120, and the CPU 130 constitute a training device 10 and a musical score creation device 20. In the present embodiment, the training device 10 and the musical score creation device 20 are configured by the common processing system 100, but they can be configured by separate processing systems.

The RAM 110 is a volatile memory, for example, and is used as a work area for the CPU 130. The ROM 120 is a non-volatile memory, for example, and stores a training program and a musical score creation program. The CPU 130 is one example of at least one processor as an electronic controller of the processing system 100. The CPU 130 executes the training program stored in the ROM 120 on the RAM 110 in order to perform a training process. In addition, the CPU 130 executes the musical score creation program stored in the ROM 120 on the RAM 110 in order to carry out the musical score creation process. Here, the term “electronic controller” as used herein refers to hardware, and does not include a human. The processing system 100 can include, instead of the CPU 130 or in addition to the CPU 130, one or more types of processors, such as a GPU (Graphics Processing Unit), a DSP (Digital Signal Processor), an FPGA (Field Programmable Gate Array), an ASIC (Application Specific Integrated Circuit), and the like. Details of the training process and the musical score creation process will be described below.

The training program or the musical score creation program can be stored in the storage unit 140 instead of the ROM 120. Alternatively, the training program or the musical score creation program can be provided in a form stored on a computer-readable storage medium and installed in the ROM 120 or the storage unit 140. Alternatively, if the processing system 100 is connected to a network, such as the Internet, a training program or a musical score creation program distributed from a server (including a cloud server.) on the network can be installed in the ROM 120 or the storage unit 140.

The storage unit (computer memory) 140 includes a storage medium such as a hard disk, an optical disk, a magnetic disk, or a memory card, and stores a trained model M and a plurality of pieces of training data D. The trained model M or each piece of the training data D can be stored in a computer-readable storage medium instead of the storage unit 140. Alternatively, in the case that the processing system 100 is connected to a network, trained model M or each piece of the training data D can be stored in a server on said network.

The trained model M is a machine learning model trained in order to estimate each note and attribute information for creating a musical score and is constructed using the plurality of pieces of training data D. The training data D represent a set of a reference note sequence, and each reference note and reference attribute information. The reference note sequence is indicated as a musical note token sequence for learning that includes (or is composed of) a plurality of reference notes that can be generated from MIDI, for example. Each reference note and the reference attribute information are represented as a musical score element token sequence.

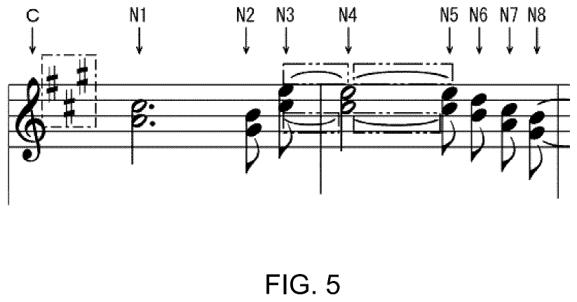

The training data D can be image data indicating an image musical score of FIG. 5, described further below. In this case, the musical note token sequence for learning and the musical score element token sequence are created from the image musical score (reference image musical score) indicated by the training data D. The trained model M is constructed by learning the input-output relationship between the musical note token sequence for learning and the musical score element token sequence. The musical note token sequence for learning and the musical score element token sequence will be described in detail below.

The operation unit (user operable input) 150 includes a keyboard or a pointing device such as a mouse and is operated by the user. The display unit (display) 160 includes a liquid-crystal display, for example. The operation unit 150 and the display unit 160 can be configured as a touch panel display.

### (2) Musical Note Token Sequence for Learning

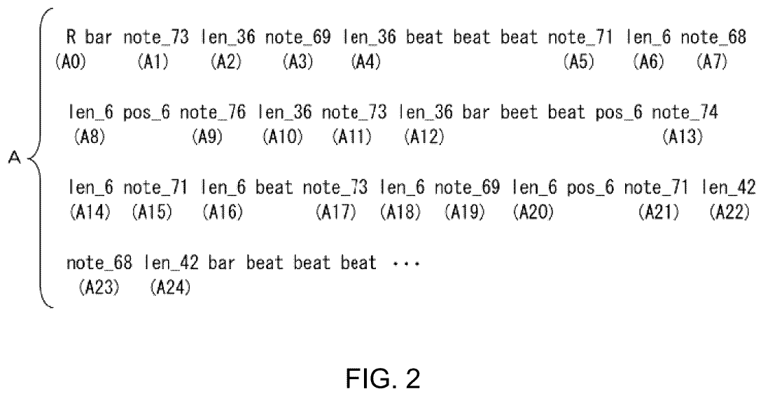

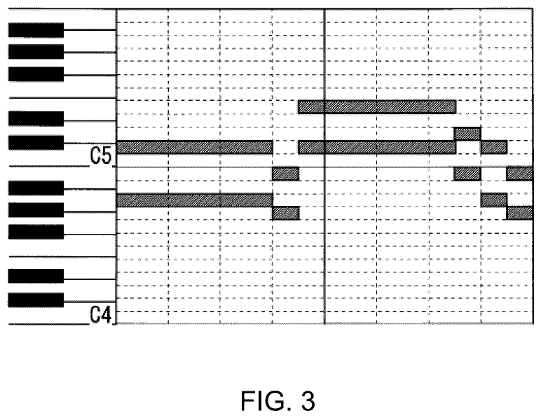

In the present embodiment, the musical note token sequence for learning includes, in addition to a reference note sequence, a part and a bar-beat structure. FIG. 2 is a diagram showing an example of the musical note token sequence for learning in each piece of the training data D. FIG. 3 is a piano roll represented by the musical note token sequence for learning A shown in FIG. 2.

As shown in FIG. 2, the musical note token sequence for learning A is basically denoted by a plurality of tokens that include tokens A0-A24 arranged in chronological order. Each token is a symbolic representation of a musical element, and some tokens have attributes. An attribute of a token is denoted in the second half of the token (after the underscore). The musical note token sequence for learning A shown in FIG. 2 is data from which the first two measures of a musical piece have been extracted.

The token A0 indicates a part. With respect to the token A0, “R” and “L” respectively indicate right- and left-hand parts. In the present embodiment, a right-hand token sequence is placed after “R.” “L” is placed thereafter, and a left-hand token sequence is placed after the “L.” “R” and the right-hand token sequence can be placed after the left-hand token sequence. In addition, the token A0 is placed at the beginning of the musical note token sequence for learning A, that is, before the reference note sequence (tokens A1-A24), but can be placed at any position in the musical note token sequence for learning A. If no distinction has been made between parts, the musical note token sequence for learning A does not include token A0.

The tokens A1-A24 correspond to the reference note sequence. A reference note in the reference note sequence is indicated by a pitch and a note value. The pitch is denoted by the “note” attribute in the tokens A1, A3, and the like. The note value is denoted by the “len” attribute in the tokens A2, A4, and the like. In the example of FIG. 2, a reference note with a pitch of “73” and a duration of 36 units is indicated by the pair of tokens A1, A2, and a reference note with a pitch of “69” and a duration of 36 units is represented by the pair of tokens A3, A4. In the piano roll of FIG. 3, key “C5” corresponds to a pitch of “72.”

“bar,” “beat,” and “pos” are tokens indicating the bar-beat structure. In the musical note token sequence for learning A, bars (measures) are separated by “bar” and beats are separated by “beat.” Also, the position of a reference note within a beat is denoted by the “pos” attribute. In the example of FIG. 2, one bar has four beats. And the length of one beat is twelve units.

The token A1 through part of token A12 (6 unit lengths of token A12) represent the reference note sequence of the first bar. Therefore, the tokens A1 to A12 are separated as a bar by “bar” before the token A1 and “bar” after the token A12. The first bar is also divided into beats by the three “beats” after the token A4. Similarly, from the remaining portion of the token A12 to a portion of token A24 (six unit lengths of token A24) represent the reference note sequence of the second bar.

### (3) Musical Score Element Token Sequence

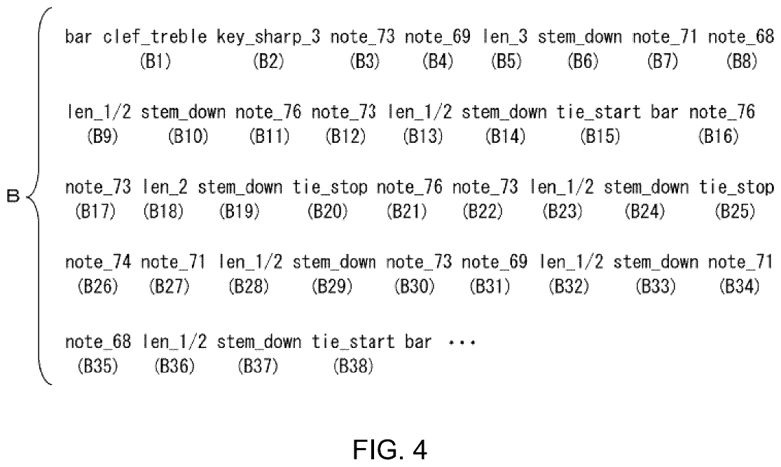

In the present embodiment, the musical score element token sequence includes information pertaining to musical note drawings, attribute, and bars for creating an image musical score. FIG. 4 is a diagram showing an example of the musical score element token sequence in each piece of the training data D. FIG. 5 is a musical score represented by a musical score element token sequence B of FIG. 4.

As shown in FIG. 4, the musical note token sequence B is basically denoted by a plurality of tokens including tokens B1-B38 arranged in chronological order. Like the tokens of the musical note token sequence for learning A, some of the tokens have attributes. The attribute of a token is denoted in the second half of the token. Also like the musical note token sequence for learning A, the musical score element token sequence B can include the tokens “R” and “L” indicating parts.

Bars (measures) are also divided by “bar” in the musical score element token sequence B. In the example of FIG. 4, the range delimited by “bar” before token B1 and “bar” after token B15 corresponds to the first bar. Therefore, the tokens B1-B15 correspond to the first bar of the musical note token sequence for learning A shown in FIG. 2. Similarly, the range delimited by “bar” before token B16 and “bar” after token B38 corresponds to the second bar. Therefore, the tokens B16-B38 correspond to the second measure of the musical note token sequence for learning A.

A reference note in a reference note sequence is indicated by a pitch and a note value in the musical score element token sequence B as well. The pitch is denoted by the “note” attribute and the note value is denoted by the “len” attribute. While “len-12” corresponds to one beat in the musical note token sequence for learning A, “len-1” corresponds to one beat in the musical score element token sequence B. The direction of the stem of the reference note is denoted by the attribute “stem.” When the attribute of “stem” is “down,” the stem is drawn to extend downward from the head of the note. On the other hand, when the attribute of “stem” is “up,” the stem is drawn to extend upward from the head of the note.

In the example of FIG. 4, the tokens B3-B6 indicate a reference note N1, the tokens B7-B10 indicate a reference note N2, the tokens B11-B14 indicate a reference note N3, and the tokens B16-B19 indicate a reference note N4. The tokens B21-B24 indicate a reference note N5, the tokens B26-B29 indicate a reference note N6, the tokens B30-B33 indicate a reference note N7, and the tokens B34-B37 indicate a reference note N8. In the tokens B9, B13, and the like, the attribute “len” is denoted by a fraction, such as ½, but can be denoted by a decimal, such as 0.5.

A reference rest in the reference note sequence is denoted by the token “rest.” The note value of the reference rest is denoted by the attribute “len,” in the same manner as the reference note. A plurality of reference notes, such as eighth notes or sixteenth notes, can be connected with a beam by using the “beam” token. The start and end positions of a beam are respectively denoted by the attributes “start” and “stop” of “beam.”

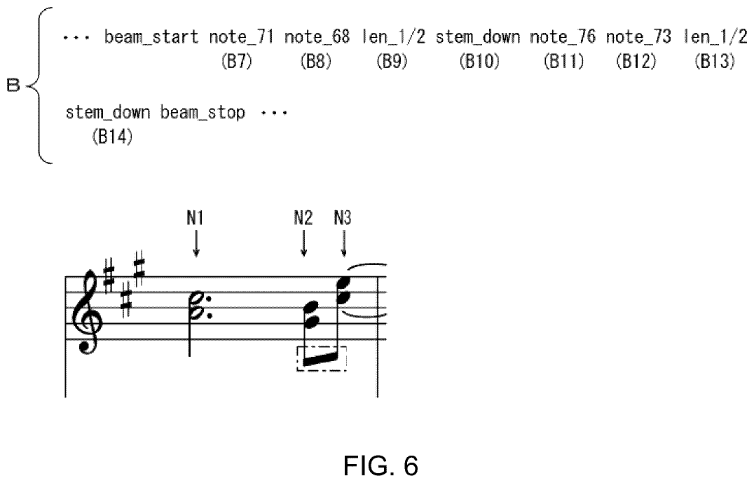

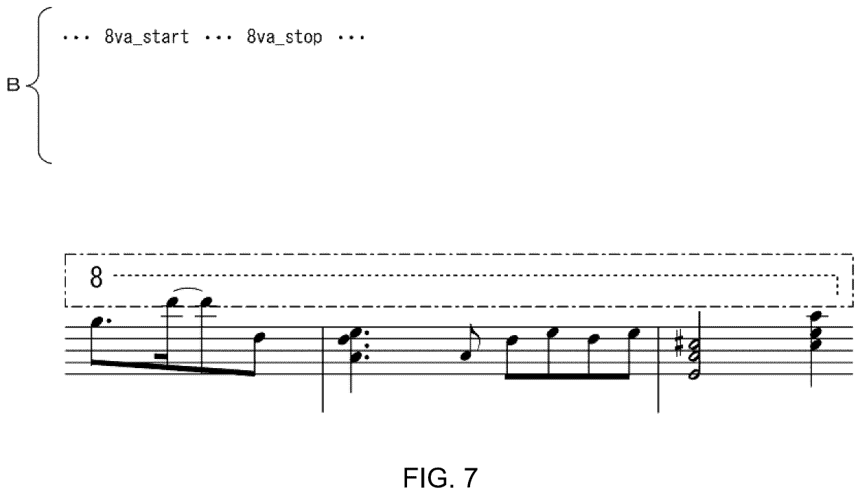

FIG. 6 is a diagram showing another example of the musical score element token sequence B in each piece of the training data D. The upper part of FIG. 6 shows a portion of the musical score element token sequence B, and the lower part shows an image musical score corresponding to the musical score element token sequence B of the upper part. The same applies to FIGS. 7-9, described further below. The tokens B7-B14 in the musical score element token sequence B of FIG. 6 are the same as the tokens B7-B14 of the musical score element token sequence B of FIG. 4.

As shown in FIG. 6, “beam_start” is placed before token B7, and “beam_stop” is placed after token B14. That is, tokens B7-B10 corresponding to reference note N2 and tokens B11-B14 corresponding to reference note N3 are sandwiched by “beam_start” and “beam_stop.” As a result, as shown by the dashed-dotted line of FIG. 6, reference note N2 and reference note N3 are connected by a beam in the image musical score.

### (4) Reference Attribute Information

In addition to the above-described tokens for drawing notes and drawing rests, the musical score element token sequence B includes tokens that denote key signatures, division and joining of note values, clefs, and voices, as reference attribute information. A specific example of the reference attribute information in the musical score element token sequence B will be described below. FIGS. 4 and 5 will be referenced to explain the musical score element token sequence B that denotes key signatures, division and joining of note values, and clefs.

As shown by token B2 of FIG. 4, a key signature is denoted by the token “key.” The type of the key signature is denoted by the attribute of “key.” For example, sharp and natural are respectively denoted by the attributes “sharp” and “natural” of “key.” In addition, the number of key signatures is denoted by an additional attribute of “key.” Therefore, the token B2 denotes three sharps encircled by the dashed-dotted line of FIG. 5. Tokens denoting the key signature appear at the beginning of the staff and the signature change position of the image musical score.

The division and joining of note values are indicated by performance symbol ties encircled by the chain double-dashed line of FIG. 5. As shown by the tokens B15, B20, B25, and B38 of FIG. 4, a performance symbol tie is denoted by the token “tie.” The start and end positions of a performance symbol tie are respectively denoted by the attributes “start” and “stop” of “tie.”

As shown by the token B1 of FIG. 4, a clef symbol is denoted by the token “clef” The type of clef is denoted by the attribute of “clef” For example, the treble clef and bass clef are respectively denoted by “treble” and “bass” as the attributes of “clef” Thus, token B1 denotes a treble clef as the clef C of FIG. 5. Tokens denoting clefs appear at the beginning of the staff and the position of a clef change in the image musical score.

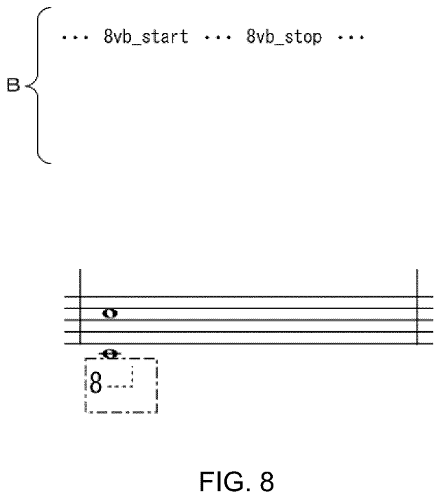

FIGS. 7 and 8 are diagrams showing another example of the musical score element token sequence B denoting clefs. The octave line that is one octave higher, encircled by the dashed-dotted line of FIG. 7, is denoted by the token “8va.” The octave line that is one octave lower, encircled by the dashed-dotted line of FIG. 8, is denoted by the token “8vb.” The start and end positions of an octave line are respectively denoted by the attributes “start” and “stop” of “8va” or “8vb.”

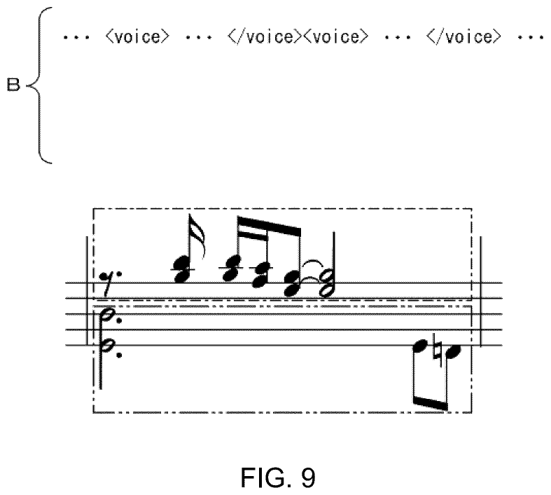

FIG. 9 is a diagram showing an example of the musical score element token sequence B denoting a voice part. The start and end positions of one of the voices encircled by the dashed-dotted line in FIG. 9 are respectively denoted by a pair of tokens “voice” and “/voice.” The start and end positions of the other voice encircled by the chain double-dashed line in FIG. 9 are respectively denoted by another pair of tokens “voice” and “/voice” placed after the above-described pair “voice” and “/voice.”

### (5) Training Device and Musical Score Creation Device

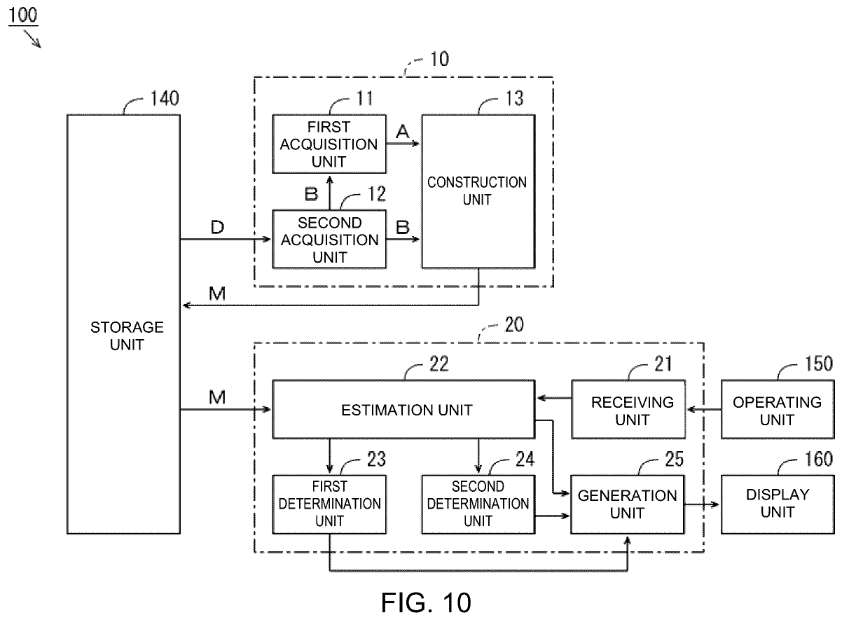

FIG. 10 is a block diagram showing the configuration of the training device 10 and the musical score creation device 20. As shown in FIG. 10, the training device 10 includes a first acquisition unit 11, a second acquisition unit 12, and a construction unit 13 as functional units. The CPU 130 of FIG. 1 executes the training program to realize/execute the functional units of the training device 10. At least some of the functional units of the training device 10 can be realized in hardware, such as electronic circuitry.

The first acquisition unit 11 acquires the musical note token sequence for learning A including a reference note sequence, a part, and a bar-beat structure, based on each piece of the training data D stored in the storage unit 140, or the like. In the present embodiment, some of the token sequences are extracted from the musical score element token sequence B acquired by the second acquisition unit 12, described further below, thereby acquiring the musical note token sequence for learning A.

The second acquisition unit 12 acquires the musical score element token sequence B including information pertaining to a note drawing(s), an attribute(s), and a bar(s), based on each piece of the training data D stored in the storage unit 140, or the like. In the present embodiment, the image musical score is analyzed to extract the note drawings, attributes, and bars included in the image musical score in chronological order. Further, each of the note drawings, attributes, and bars extracted in chronological order is converted into a token in accordance with a preset conversion table. The musical score element token sequence B is thereby acquired.

A construction unit 13 causes the machine learning model to learn each piece of the training data D using the musical note token sequence for learning A acquired by the first acquisition unit 11 as input and the musical score element token sequence B acquired by the second acquisition unit 12 as output. By repeating machine learning for the plurality of pieces of the training data D, the construction unit 13 constructs the trained model M representing the input-output relationship between the musical note token sequence for learning A and the musical score element token sequence B.

In the present embodiment, the construction unit 13 trains a Transformer to construct the trained model M, but the embodiment is not limited in this way. The construction unit 13 can train a machine learning model of another method of handling a time series to construct the trained model M. The trained model M constructed by the construction unit 13 is stored in the storage unit 140, for example. The trained model M constructed by the construction unit 13 can be stored on a server on a network.

The musical score creation device 20 includes a receiving unit 21, an estimation unit 22, a first determination unit 23, a second determination unit 24, and a generation unit 25 as functional units. The CPU 130 of FIG. 1 executes a musical score creation program to realize/execute the functional units of the musical score creation device 20. At least some of the functional units of the musical score creation device 20 can be realized in hardware, such as electronic circuitry. The musical score creation device 20 can also be incorporated in music engraving software or a digital audio workstation (DAW).

The receiving unit 21 receives an input note token sequence including a note sequence including (or composed of) a plurality of musical notes. By operating the operation unit 150, the user can generate an input note token sequence, which is provided to the receiving unit 21. The input note token sequence has the same configuration as the musical note token sequence for learning A shown in FIG. 2. That is, the input note token sequence has a part and a bar-beat structure as well as the note sequence.

The estimation unit 22 uses the trained model M stored in the storage unit 140, or the like to estimate a musical score token sequence including notes and attribute information for creating a musical score from the input note token sequence. The musical score token sequence indicates a token sequence corresponding to the input note token sequence received by the receiving unit 21, and is estimated based on the note sequence, the part, and the bar-beat structure. Since the input note token sequence has the same configuration as the musical note token sequence for learning A, the musical score token sequence has the same configuration as the musical score element token sequence B.

The first determination unit 23 determines an accidental based on the musical score token sequence estimated by the estimation unit 22. An accidental is determined, for example, from the key signature and pitch in the musical score token sequence. An accidental of a preceding note can be further used to determine a subsequent accidental. The second determination unit 24 determines a time signature based on the musical score token sequence estimated by the estimation unit 22. The time signature is determined, for example, from the number of beats in each measure in the musical score token sequence.

The generation unit 25 generates musical score information indicating a musical score describing each note and attribute information from the musical score token sequence estimated by the estimation unit 22. That is, the generation unit 25 functions as a creation unit, and generates musical score information in a musical score format from the musical score token sequence. The musical score information can be text data in the MusicXML format, for example. The display unit (display) 160 displays the image musical score indicated by the musical score information generated by the generation unit 25.

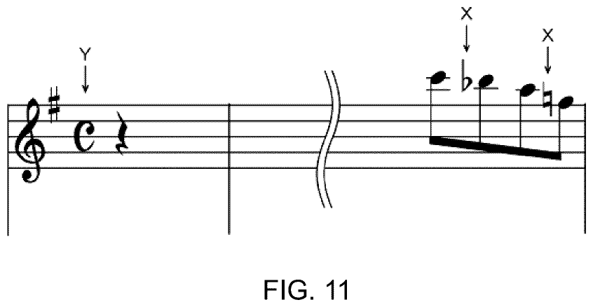

FIG. 11 is a diagram showing an example of an image musical score. As shown in FIG. 11, accidentals X determined by the first determination unit 23 can be further denoted in the image musical score. Further, a time signature Y determined by the second determination unit 24 can also be denoted in the image musical score. Here, as long as there is no change in the time signature, time signature Y can be denoted only at the beginning of the musical score.

### (6) Training Process and Musical Score Creation Process

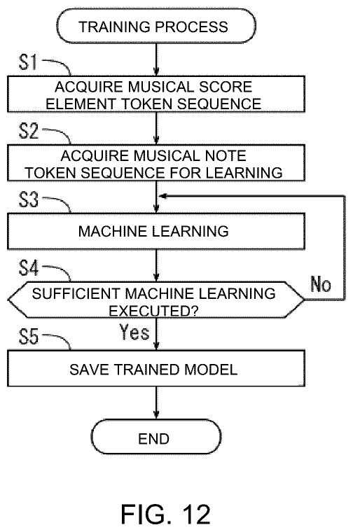

FIG. 12 shows a flowchart of an example of the training process conducted by the training device 10 of FIG. 10. The training process of FIG. 12 is performed when the CPU 130 of FIG. 1 executes the training program. First, the second acquisition unit 12 acquires the musical score element token sequence B from each piece of the training data D (Step S1). The first acquisition unit 11 acquires the musical note token sequence for learning A corresponding to the musical score element token sequence B from the musical score element token sequence B acquired in Step S1 (Step S2).

The construction unit 13 then performs machine learning on each piece of the training data D using the musical score element token sequence B acquired in Step S1 as an output token, and the musical note token sequence for learning A acquired in Step S2 as an input token (Step S3). The construction unit 13 then determines whether sufficient machine learning has been performed (Step S4). If insufficient machine learning has been performed, the construction unit 13 returns to Step S3. Steps S3 and S4 are repeated while the parameters are changed until sufficient machine learning has been performed. The number of machine learning iterations varies in accordance with the quality conditions that should be met by the trained model M to be constructed.

If sufficient machine learning has been performed, the construction unit 13 stores the input-output relationship between the musical score element token sequence B and the musical note token sequence for learning A learned by machine learning in Step S3 as the trained model M (Step S5). The training process is thus completed.

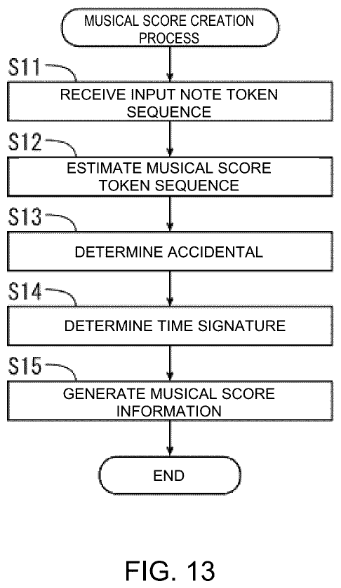

FIG. 13 is a flowchart showing an example of the musical score creation process performed by the musical score creation device 20 of FIG. 10. The musical score creation process of FIG. 13 is performed when the CPU 130 of FIG. 1 executes the musical score creation program. First, the receiving unit 21 receives an input note token sequence (Step S11). The estimation unit 22 then uses the trained model M stored in Step S5 of the training process to estimate the musical score token sequence from the input note token sequence received in Step S11 (Step S12).

The first determination unit 23 then determines the accidental based on the musical score token sequence estimated in Step S12 (Step S13). In addition, the second determination unit 24 determines the time signature based on the musical score token sequence estimated in Step S12 (Step S14). Either Step S13 or S14 can be executed first, or the steps can be executed simultaneously.

The generation unit 25 then generates musical score information based on the musical score token sequence estimated in Step S12, the accidental determined in Step S13, and the time signature determined in Step S14 (Step S15). An image musical score can be displayed on the display unit 160 based on the generated musical score information. The musical score creation process is thus completed.

### (7) Effects of the Embodiment

As described above, the musical score creation device 20 according to the present embodiment comprises the receiving unit 21 for receiving a sequence of notes including a plurality of musical notes, and the estimation unit 22 for using the trained model M to estimate each note and attribute information for creating a musical score. The trained model M is a machine learning model that has learned the input-output relationship between a reference note sequence composed of a plurality of reference notes, and each reference note and reference attribute information for creating a musical score (reference musical score).

By this configuration, since each note and attribute information corresponding to the note sequence is estimated by using the trained model M, it is possible to denote, not only musical notes, but also attribute information, in the musical score. It is thus possible to create a practical musical score.

The musical score creation device 20 can further comprise the generation unit 25 for generating musical score information indicating a musical score describing attribute information and each note that has been estimated. In this case, the user does not need to generate musical score information from the notes and attribute information, thereby improving usability.

That is, the musical score creation device 20 according to the present embodiment comprises the receiving unit 21 for receiving an input note token sequence, which is performance data including musical note, part, and beat information; the estimation unit 22 that converts an image musical score into a musical score element token sequence including musical note drawings, attributes, and measure information, that creates a musical note token sequence for learning from the musical score element token sequence using the trained model M that has been taught, where the musical note token sequence for learning is the input and a musical score token is the output, to estimate a musical score token sequence from the input note token sequence; and a creation unit for creating an image musical score from the musical score token sequence.

The estimation unit 22 can estimate a key signature as attribute information. The estimation unit 22 can estimate the division and joining of note values as attribute information. The estimation unit 22 can estimate a clef as attribute information. The estimation unit 22 can estimate a voice as attribute information. The musical score creation device 20 can further comprise the first determination unit 23 for determining an accidental based on attribute information and each estimated note. The musical score creation device 20 can further comprise the second determination unit 24 for determining a time signature based on attribute information and each estimated note. In these cases, a more practical musical score can be created.

The training device 10 according to the present embodiment comprises the first acquisition unit 11 that acquires a reference note sequence composed of a plurality of reference notes, the second acquisition unit 12 that acquires each reference note and reference attribute information for creating a musical score, and the construction unit 13 that constructs the trained model M that has learned the input-output relationship between the reference note sequence, each of the reference notes, and the reference attribute information. By this configuration, a trained model M that has learned the input-output relationship between the reference note sequence, each of the reference notes, and the reference attribute information can easily be constructed.

### (8) Other Embodiments

In the embodiment described above, the musical note token sequence for learning A includes a part and a metrical structure (bar-beat structure), but the embodiment is not limited in this way. The musical note token sequence for learning A need only include a reference note sequence and need not include a part and bar-beat structure. The same is true for the input note token sequence. In addition, the musical score element token sequence B includes information pertaining to measures, but the embodiment is not limited in this way. The musical score element token sequence B need only include the reference notes and reference attribute information and need not include measure information. The same is true for the musical score token sequence.

In the embodiment described above, the musical score creation device 20 includes the generation unit 25, but the embodiment is not limited in this way. The user can create a musical score based on the musical score token sequence estimated by the estimation unit 22. Therefore, the musical score creation device 20 need not include the generation unit 25.

In the embodiment described above, the musical score creation device 20 includes the first determination unit 23 and the second determination unit 24, but the embodiment is not limited in this way. If it is not necessary for the musical score to include any accidentals, the musical score creation device 20 need not include the first determination unit 23. If it is not necessary for the musical score to include the time signature, the musical score creation device 20 need not include the second determination unit 24.

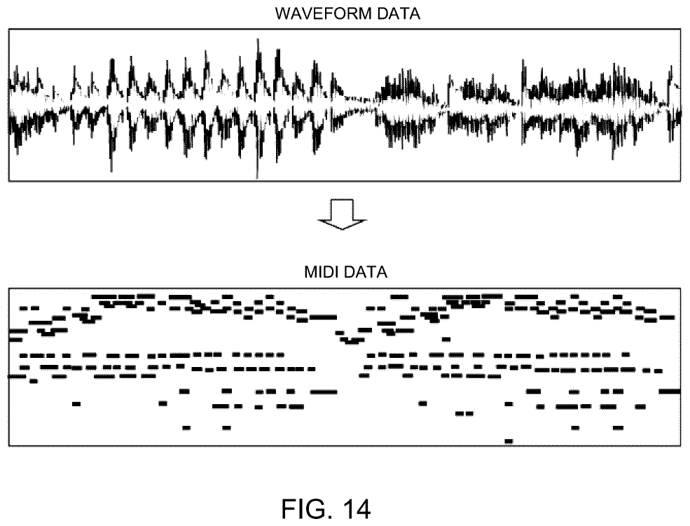

In the present embodiment, by operating the operation unit 150, the user can generate an input note token sequence, which is provided to the receiving unit 21, but the embodiment is not limited in this way. FIG. 14 is a diagram for explaining the operation of the receiving unit 21 in another embodiment. As shown in the upper part of FIG. 14, the user can provide the receiving unit 21 with waveform data generated by a piano performance, or the like.

In this case, as shown in the lower part of FIG. 14, the receiving unit 21 converts the provided waveform data into MIDI data and obtains the input note token sequence from the converted MIDI data. Therefore, the receiving unit 21 receives the input note token sequence in the form of waveform data. By this configuration, a musical score that describes a performance can be generated from waveform data of the performance.

In the embodiment described above, the receiving unit 21 can receive an input note token sequence in which right-hand part tokens and left-hand part tokens are mixed. Even in this case, it is possible to use the trained model M that has been appropriately trained to estimate a musical score token sequence in which the right-hand part tokens and the left-hand part tokens are separated.

### Effects

By this disclosure, it is possible to create a practical musical score.

What is claimed is:

1. A musical score creation device comprising:
at least one processor configured to execute
a receiving unit configured to receive a note sequence that includes a plurality of musical notes, and
an estimation unit configured to, by using a trained model, estimate each note and attribute information for creating a musical score,
the trained model being a machine-learning model that has learned an input-output relationship between a reference note sequence including a plurality of reference notes, and each reference note and reference attribute information for creating a reference musical score.

2. The musical score creation device according to claim 1, wherein
the at least one processor is further configured to execute a generation unit configured to generate musical score information indicating the musical score that describes each note and the attribute information that have been estimated.

3. The musical score creation device according to claim 1, wherein
the estimation unit is configured to estimate a key signature as the attribute information.

4. The musical score creation device according to claim 1, wherein
the estimation unit is configured to estimate division and joining of note values as the attribute information.

5. The musical score creation device according to claim 1, wherein
the estimation unit is configured to estimate a clef as the attribute information.

6. The musical score creation device according to claim 1, wherein
the estimation unit is configured to estimate voice as the attribute information.

7. The musical score creation device according to claim 1, wherein
the at least one processor is further configured to execute a first determination unit configured to determine an accidental based on each note and the attribute information that have been estimated.

8. The musical score creation device according to claim 1, wherein
the at least one processor is further configured to execute a second determination unit configured to determine a time signature based on each note and the attribute information that have been estimated.

9. A musical score creation device comprising:
at least one processor configured to execute
a receiving unit configured to receive an input note token sequence, which is performance data including information on a musical note, a part, a beat, and a bar,
an estimation unit configured to estimate a musical score token sequence from the input note token sequence, by using a trained model that has been trained by using a musical note token sequence for learning as an input and a musical score element token sequence as an output, the musical score element token sequence being converted from a reference image musical score and including information on a musical note drawing, an attribute, and a bar, the musical note token sequence for learning being created from the musical score element token sequence, and
a creation unit configured to create an image musical score from the musical score token sequence.

10. A training device comprising:
at least one processor configured to execute
a first acquisition unit configured to acquire a reference note sequence including a plurality of reference notes,
a second acquisition unit configured to acquire each reference note and reference attribute information for creating a musical score, and
a construction unit configured to construct a trained model that has learned an input-output relationship between the reference note sequence, and each reference note and the reference attribute information.

11. A musical score creation method executed by a computer, the musical score creation method comprising:
receiving a note sequence including a plurality of musical notes; and
estimating each note and attribute information for creating a musical score, by using a trained model,
the trained model being a machine learning model that has learned an input-output relationship between a reference note sequence including a plurality of reference notes, and each reference note and reference attribute information for creating a reference musical score.

12. The musical score creation method according to claim 11, further comprising generating musical score information indicating the musical score that describes each note and the attribute information that have been estimated.

13. The musical score creation method according to claim 11, wherein
in the estimating, a key signature is estimated as the attribute information.

14. The musical score creation method according to claim 11, wherein
in the estimating, division and joining of note values are estimated as the attribute information.

15. The musical score creation method according to claim 11, wherein
in the estimating, a clef is estimated as the attribute information.

16. The musical score creation method according to claim 11, wherein
in the estimating, voice is estimated as the attribute information.

17. The musical score creation method according to claim 11, further comprising determining an accidental based on each note and the attribute information that have been estimated.

18. The musical score creation method according to claim 11, further comprising determining a time signature based on each note and the attribute information that have been estimated.

19. A training method executed by a computer, the training method comprising:
acquiring a reference note sequence including a plurality of reference notes;
acquiring each reference note and reference attribute information for creating a musical score; and
constructing a trained model that has learned an input-output relationship between the reference note sequence, and each reference note and the reference attribute information.
